(19) United States
(12) Patent Application Publication
(10) Pub. No.: US 2012/0061593 A1
(43) Pub. Date: Mar. 15, 2012

(54) Charged-Particle Beam Lithographic Apparatus and Lithographic Method Therefor

(75) Inventor: Yuichi Kawase, Tokyo (JP)

(73) Assignee: JEOL LTD., Tokyo (JP)

(21) Appl. No.: 13/229,986

(22) Filed: Sep. 12, 2011

(30) Foreign Application Priority Data
Sep. 13, 2010 (JP) 2010-204193

(51) Int. Cl. G21K 5/10

(52) U.S. Cl. 250/492.3

(57) ABSTRACT

A charged-particle beam lithographic method is implemented by irradiating resist applied on a material surface with successive shots of a variably shaped charged-particle beam. A table is drawn up which indicates the relations of the distances of each shot of interest to adjacent shots to corresponding amounts of correction applied to sides of the shot of interest taking account of the influence of forward scattering. Corrective shot data is found from the table by translating the sides of the shot of interest located opposite to the adjacent shots. Corrective values for a proximity effect produced under the influence of backward scattering are calculated based on the corrective shot data. The shots of the beam are carried out based on the corrective shot data and on the corrective values.

### BACKGROUND OF THE INVENTION

1. Field of the Invention

The present invention relates to a charged-particle beam lithographic apparatus and a lithographic method adapted for use by the lithographic apparatus and, more particularly, to a charged-particle beam lithographic method and apparatus capable of improving the accuracy of proximity effect corrections.

2. Description of Related Art

A charged-particle beam lithographic apparatus is an instrument for delineating a pattern on a material surface by the use of a charge-particle beam, the material consisting of a dry plate on which resist is applied. In this type of apparatus, if a material surface is irradiated with a charged-particle beam, the beam incident on the resist is scattered within the resist, thus deteriorating the accuracy at which a pattern is written. This is known as a proximity effect.

Proximity effect corrections are described below. In charged-particle beam lithography, a shot charged-particle beam scatters within resist (known as forward scattering) and passes into the substrate through the resist. Then, the beam is again scattered into the resist from the substrate (known as backward scattering). Consequently, energy is stored in portions close to the irradiated portion, as well as in the irradiated portion.

FIG. 9 illustrates the energy distributions produced on occurrence of forward scattering and backward scattering. The horizontal axis indicates position, while the vertical axis indicates charged-particle energy. Indicated by A is an ideal storage of the charged-particle energy. B indicates the influence of forward scattering. C indicates the influence of backward scattering. D indicates the range of influence of the forward scattering. E indicates the range of influence of the backward scattering. It can be seen that the range of influence of the backward scattering is wide-spreading.

As a result, where a development step is performed at a constant process level, if pattern elements of the same linewidth are written with the same shot time of charged-particle beam, closely spaced pattern elements ((b)-(d) of FIG. 10) produce thicker lines than a line produced by a sparsely spaced, isolated pattern element ((a) of FIG. 10). FIG. 10 illustrates the influence of a proximity effect on the pattern linewidth after a development process. The horizontal axis indicates position, whereas the vertical axis indicates charged-particle energy. A process level (energy level) necessary for a process is indicated by L. This phenomenon is known as a proximity effect. Especially, a proximity effect due to backward scattering exerts a relatively large effect. Therefore, from around the time at which pattern delineation using a charged-particle beam was started, various countermeasures (proximity effect corrections) were already taken by adjusting the shot time of a charged-particle beam to correct the dosage, for reducing the effects.

A correction of a proximity effect due to backward scattering is next described.

### (I) Estimation of Proximity Effect

The magnitude of a proximity effect depending on a lithographic pattern is estimated. First, it is assumed that the influence of a proximity effect depends on the amount of electron energy (scattering electron energy) stored in an arbitrary position on a material, the electron energy being produced by scattering of an electron beam within resist or on a material surface after the beam is emitted to delineate a pattern.

It is considered that the magnitude (amount) of the scattering electron energy stored at the arbitrary position on the material is in proportion to the accumulated value of the amount of influence of the scattering electron energy which depends on the density of the electron beam illuminating the surroundings and on the distance from the beam position on the material.

The amount of the scattering electron energy stored is found by making an approximation for each tiny region (partition) virtually arranged over the whole lithographic field, the region measuring approximately 0.5 μm or 1 μm square. The amount of electron energy incident on each partition of the delineated pattern is accumulated according to the ratio of the amount of electron energy incident on the partition while adjusting the amounts of influence of the scattering electron energy on the partition and on adjacent partitions (i.e., the total amount of influence). FIG. 11 shows a layout of pattern data. At this time, the amounts of influence of scattering electron energy on the partition and on the adjacent partitions exerted by the emitted electron beam are specified as a distribution of amounts of influence among individual partitions (energy distribution reference table) using a separate parameter. FIG. 12 shows an example of the energy distribution reference table (Eid_{j,i}). In the table, electron energy distribution is expressed by integral values 0-4095 (12 bit) for example, wherein the intensity Eid0,0 of the center partition ((j, i)=(0, 0)), indicates the intensity of backward scattering electron energy at the irradiated partition and is given the maximum integral value of 4095.

Based on the amounts of stored scattering electron energy found in this way at each position on an arbitrary lithographic field, the distribution (stored energy distribution map) is found. FIG. 13 shows an example of the stored energy distribution map (Eb p_{n,m}). When an arbitrary geometric figure (k) is delineated, (Eb p_{n,m}) is computed by causing hardware to perform arithmetic processing conforming to Eq. (1) from the ratio (E(k)_{n,m}) of the amount of electron energy impinging on each partition (n, m) and from the distribution (Eid_{j,i}) of backward scattering electron energy intensities imparted to the peripheral partitions (j, i) by the impinging electrons:

$${Ebp}_{n , m} = \frac{{\sum }_{k = 1}^{f} {\sum }_{i = - r}^{r} {\sum }_{j = - r}^{r} {E ( k )}_{n + j , m + i} \times {Eid}_{j , i}}{{\sum }_{i = - r}^{r} {\sum }_{j = - r}^{r} {Eid}_{j , i}} \qquad ( 1 )$$

where the ratio (E(k)_{n,m}) of the amount of incident electron energy is expressed as a ratio taken under the condition where the amount of energy assumed when an electron beam impinges on the whole one partition at a given intensity is set to 100%. The intensity of backward scattering electron energy (Eidj,i) in Equation (1) is expressed as a ratio to the intensity of backward scattering electron energy at the irradiated partition, namely, 4095.

The distribution of backward scattering electron energy intensities has been specified as an electron energy distribution parameter (energy distribution reference table) using a separate parameter (see FIG. 12). r is the number of partitions encountered until a peripheral partition for which the influence of backscattering electrons is considered is reached. f is the number of geometric figures contained in the pattern data. The amount of storage of the obtained scattering electron energy (Ebp) is expressed as such a ratio that the amount of storage of scattering electron energy at an arbitrary position of an infinite region that has been marked out is set to 100%.

At this time, consideration is given to the fact that electron energy given by scattering of the electron beam from the vicinities arises from surrounding fields and nearby chips as well as from within the same field. It is estimated that the calculated amount of storage of scattering electron energy per partition represents the magnitude of the influence of the proximity effect.

### (II) Calculation of Amount of Correlation to Proximity Effect

An amount of correction to the time (shot time) for which the material surface is irradiated with an electron beam when a pattern is delineated on the material surface is calculated according to the magnitude of a proximity effect. Based on a stored energy distribution map obtained in (a) and corresponding to one lithographic field, an amount of correction to the irradiation time of each shot of electron beam is calculated regarding each partition defined by lithographic pattern data. The amount of correction to the irradiation time of the electron beam is found from a relational formula conforming to Eq. (2) (described later) as an amount of modulation (S mod) of shot time relative to the ratio (Ebp) of the intensity of stored energy of backward scattering electrons.

The contents of the relational formula have been set as a “proximity effect correcting table (stored energy conversion table)” using a separate parameter. FIG. 14 shows an example of the stored energy conversion table. The horizontal axis indicates the ratio (Ebp %) of the intensity of stored energy of scattering electrons. The vertical axis indicates the amount of modulation of shot time (S mod %). It can be seen that the amount of modulation of shot time assumes a positive or negative value depending on the ratio of the intensity of stored energy of scattering electrons. The amount of modulation of shot time is expressed as a ratio (%) of an increase or decrease in the irradiation time to a reference beam irradiation time:

$$Smod = \frac{C 1}{1 + C 2 \times Ebp \times η} - 1 \qquad ( 2 )$$

where S mod is an amount of modulation of shot time, C1 and C2 are constants, and is a backward scattering coefficient. Eq. (2) has been derived under the assumption that as the uncorrected intensity (Da) of incident electron energy increases or decreases in proportion to a shot time correction amount (coefficient S mod+1) applied to an arbitrary tiny region (partition), the uncorrected intensity of backscattering electron energy (Da×Ebp×η) also increases or decreases only in proportion to the shot time correction amount (coefficient S mod+1) applied to the partition.

In particular, let the sum of the corrected intensity of incident electron energy (Da×(S mod+1)) multiplied by 1/C2 and the intensity of backward scattering electron energy (Da×Ebp×η×(S mod+1)) be the intensity of absorbed electron energy. The shot time is corrected using (coefficient S mod+1) according to the ratio (Ebp) of the intensity of stored energy of backscattered electrons such that the level of the intensity of absorbed electron energy is constant (CONST) regardless of the ratio (Ebp) of the intensity of stored energy of backscattered electrons. FIGS. 15A and 15B illustrate shot time correction. FIG. 15A shows an uncorrected energy. FIG. 15B shows a shot-corrected energy. Uncorrected base portion 1 and peak portion 2 are multiplied by the amount of modulation of shot time (S mod+1). It is seen that the energy during shot has been reduced.

Based on a stored energy conversion table obtained in this way, a distribution of amounts of correction (proximity effect correction amount map) to the shot time taken to irradiate each partition with an electron beam is found from a stored energy distribution map. FIG. 16 is a proximity effect correction amount map of irradiation times found in this way.

### (III) Re-Estimation (Recalculation) of Proximity Effect

In (I) and (II), a stored energy distribution map was created based on the assumption that patterns were delineated with a constant shot time (i.e., no proximity effect correction was made), and an amount of correction to the shot time taken to irradiate each partition with an electron beam so as to nullify the influence of the proximity effect is found for each partition. That is, no consideration is given even to the situation where the intensity of backscattering electron energy on an arbitrary partition increases or decreases dependently on the shot time correction amount (coefficient S mod+1) applied to surrounding partitions excluding that partition.

Therefore, in cases where a proximity effect correction is made and the ratio (Ebp) of the intensity of stored energy on the partition of interest is varied to Ebp′ by the influence of shot time correction on surrounding partitions, the influence of the proximity effect cannot be sufficiently corrected.

FIGS. 17A and 17B show the results of a computational correction and the results of an actual correction. FIG. 17A shows the results of the computational correction. FIG. 17B shows the results of the actual correction. As can be seen by comparison of FIGS. 17A and 17B, the results of the actual correction are not identical with the results of the computational correction. They are different in base portion size. In FIG. 17A, the base portion 1 is Da×Ebp×η×(S mod+1). In FIG. 17B, the base portion 1′ is Da×Ebp′×η. Thus, the formulas for the derivations are different.

Accordingly, the magnitude of the influence of the proximity effect produced at that time is re-estimated by applying the proximity effect correction amount map obtained in (II) and making an assumption that one lithographic field of pattern has been delineated while correcting the shot time taken to irradiate each tiny region (partition) with the electron beam (i.e., a lithographic delineation is performed while performing a proximity effect correction).

A stored energy map is found in the same way as in (I). However, when a stored energy intensity ratio map of backscattered electrons (stored energy distribution map) is computed from ratios (E(k)n,m) of the amount of incident electron energy for each partition (n, m), consideration is given to the estimation that the ratio (Ebp n,m) of the stored energy intensity of backscattered electrons at an arbitrary microscopic region (partition)(m, n) increases or decreases to (Ebp′ n,m) dependently on the electron beam dose in surrounding partitions (m±r, n±r). That is, a stored energy distribution map is computationally found by modifying the processing routine conforming to Eq. (1) to a processing routine conforming to Eq. (3). (Ebp′ n,m) is given by:

$${Ebp}_{n , m} = \frac{{\sum }_{k = 1}^{f} {\sum }_{i = - r}^{r} {\sum }_{j = - r}^{r} {E ( k )}_{n + j , m + i} \times {Eid}_{j , i} \times ( {Smod}_{n + j , m + i} + 1 )}{{\sum }_{i = - r}^{r} {\sum }_{j = - r}^{r} {Eid}_{j , i}} \qquad ( 3 )$$

where S mod given to the relational formula conforming to Eq. (3) in the first recalculation is an amount of modulation applied to the shot time taken to irradiate each microscopic region (partition) obtained at the first calculation (zeroth recalculation).

### (IV) Calculation of Amount of Correction to Proximity Effect (Recalculation)

An amount of correction to the electron beam irradiation time for each partition is found based on the stored energy distribution map corresponding to one lithographic map and obtained in (III). This is found as a shot time modulation amount (S mod) relative to the ratio (Ebp′) of the intensity of stored energy of backscattered electrons from a relational formula conforming to Eq. (4) described later and is set as “proximity effect correction table (stored energy conversion table)” using a separate parameter. FIG. 18 is a graph showing an example of the stored energy conversion table. The horizontal axis indicates the ratio (Ebp) (%) of the intensity of stored energy of scattering electrons. The vertical axis indicates the amount of correction to the shot time (S mod)(%). In the graph, curve f1 indicates a characteristic based on a first calculation. Curve f2 indicates a characteristic obtained by a recalculation:

S mod=C1−(1+C2×Ebp′×η) (4)

In Eq. (4), consideration is given to the fact that the shot time correction amount (coefficient S mod+1) already obtained by the first calculation (zeroth recalculation) according to a relational form a conforming to Eq. (3) is applied to the ratio (Ebp′) of the intensity of stored energy of backscattered electrons at an arbitrary microscopic region (partition).

Specifically, the sum of the corrected intensity of incident electron energy (Da×(S mod+1)) multiplied by 1/C2 and the recalculated intensity of backscattered electron energy (Da×Ebp′×η) is defined to be the intensity of absorbed electron energy. The shot time is corrected using (coefficient S mod+1) according to the ratio (Ebp′) of the intensity of stored energy of backscattered electrons such that the level of the recalculated intensity is constant (Const) without relying on the ratio (Ebp′) of the intensity of stored energy of backscattered electrons.

FIGS. 19A and 19B illustrate shot time correction. FIG. 19A shows an uncorrected state, while FIG. 19B shows a corrected state. The two states are identical in base portion but different in spectral portion. That is, (1/C2)×Da×(S mod_{before}+1) has varied to (1/C2)×Da×(S mod+1). Da×(S mod_{before}+1) has varied to Da×(S mod+1).

S mod given to Eq. (3) in the second or subsequent recalculation is the amount of shot time modulation regarding each microscopic region (partition) and obtained from a proximity effect correction table (stored energy conversion table) conforming to Eq. (4) by the previous recalculation. Then, the amount of modulation of shot time for each microscopic region (partition) is found from the ratio (Ebp′) of the intensity of stored energy of backscattered electrons, the ratio being again obtained by the use of a relational formula conforming to Eq. (3).

This operation for recalculation is repeated as many times as specified by a separate parameter to optimize the ratio (Ebp n,m) of the intensity of stored energy of backscattering electrons at an arbitrary microscopic region (partition) (m, n) to value (Ebp′ n,m), and uses the result as a stored energy distribution map. This sequence of processing is carried out for each lithographic field using dedicated hardware. A distribution (proximity effect correction amount map) of the amounts of correction to the shot time taken to irradiate each microscopic region (partition) with an electron beam is found from the optimized stored energy distribution map using a proximity effect correction table (stored energy conversion table) conforming to Eq. (4).

### (V) Execution of Proximity Effect-Corrected Lithography

The calculations of (I)-(IV) above are carried out for each lithographic field in parallel with delineation of pattern data by dedicated hardware equipped to the lithographic apparatus. FIG. 20 shows an example of configuration of a related art system. The system includes a computer system 40 for controlling the equipment, a hardware data routing system 20 for normal lithography, a hardware data routing system 30 for proximity effect correction, and an EB-lithography system 80.

The hardware data routing system 20 for normal lithography includes a register 11 for correcting the dose within a dry plate plane, a library expansion portion 12 receiving data from the computer system 40 and expanding a library, a memory 13 in which data in the form of an expanded library is stored, and a data division portion 14 for dividing the data in the form of the expanded library into groups each corresponding to a shot. The register 11 sets an amount of modulation given to a shot time for each lithographic field supplied from the computer system 40 and stores the set amount therein.

The data routing system 20 further includes a shot time calculating portion 15 for calculating shot times. Data from the register 11 for correction of the dose within the dry plate surface, data from a shot rank conversion table 16, data from a shot size conversion table 17, and data from a proximity effect correction amount map 18 are supplied to the shot time calculating portion 15. The shot time calculating portion 15 calculates shot times by computationally handling the input data and gives the calculated times to the EB-lithography system 80 to perform beam lithography.

The hardware data routing system 30 for proximity effect correction includes an incident electron energy ratio calculating portion 62 for calculating ratios of incident electron energies, an energy distribution reference table 61 receiving data from the computer system 40 and storing energy distribution reference data therein, an electron energy accumulator portion 63 receiving data stored in the reference table 61 and data from the energy ratio calculating portion 62 and performing an electron energy accumulation, and a stored energy distribution map 64 created by the electron energy accumulator portion 63.

A stored energy conversion table 65 for a first calculation is connected with the computer system 40 for controlling the apparatus. A stored energy converter portion 66 receives the outputs from the stored energy distribution map 64 and from the stored energy conversion table 65 and converts the stored energy. A proximity effect correction amount map 67 stores the results of conversion made by the converter portion 66. The proximity effect correction amount map is based on the first calculation.

An electron energy accumulator portion 68 receives the output from the incident electron energy ratio calculating portion 62, the energy distribution reference table 61, and a proximity effect correction amount map 72 created by a recalculation and accumulates electron energies. A stored energy distribution map 69 stores data obtained by the accumulation. A stored energy conversion table 70 for recalculation receives data from the computer system 40 and stores the data. A stored energy converter portion 71 receives the output from the stored energy conversion table 70 and the output from the stored energy distribution map 69 and converts the stored energy. The data obtained by the stored energy converter portion 71 is stored as a proximity effect correction amount map in the proximity effect correction amount map 72 and routed to the proximity effect correction amount map 18 for normal lithography. The operation of the system constructed in this way is described below.

The energy distribution reference table 61 and the stored energy conversion table 65 are previously routed to the hardware data routing system 30 for proximity effect correction. The routing system 30 routes successive sets of all pattern data for proximity effect-corrected lithography to the hardware data routing system 20 for proximity effect correction simultaneously with the start of a lithographic process (start of an operation for loading in a lithographic material). At this time, the ratio of the incident electron energy amount used on delineation of each microscopic region (partition) of pattern having a specified size is calculated.

Prior to lithography of one field, the hardware data routing system 30 for proximity effect correction causes amounts of scattering electron energy distributed as shown in the energy distribution reference table 61 to be accumulated in the stored energy distribution map 64 for each microscopic region (partition) according to the ratio of the amount of incident electron energy for the region. In order to create a stored energy distribution map 64 for one lithographic field, amounts of scattering electron energy are similarly accumulated for data about surrounding fields (creation of the stored energy distribution map 64), and the influence of the scattering electron energy received from the surrounding fields is taken into account.

At the instant when a stored energy distribution map about one lithographic field is completed, the map is converted into the proximity effect correction amount map 67 using the stored energy conversion table 65. In a case where a recalculation is performed, the amounts of correction stored in the obtained proximity effect correction amount map 67 are multiplied by their respective ratios of the incident electron energy amount for the individual microscopic regions (partitions), the ratios being delivered from the incident energy ratio calculating portion 62. Thus, the stored energy distribution map 69 is re-created. The operation for converting the map 69 into the proximity effect correction amount map 72 again using the stored energy conversion table 70 is performed repeatedly as many as the specified number of recalculations. The obtained proximity effect correction amount map 72 is routed to the hardware data routing system 20 for normal lithography.

When the reception of the routed proximity effect correction amount map about the delineated field is completed, the hardware data routing system 20 for normal lithography starts to write the field lithographically. At this time, a double-buffer memory may be used as a memory that receives the proximity effect correction amount map 72. In this case, the proximity effect correction amount map 72 for the next lithographic field can be received while one field is being delineated.

Concomitantly with start of a lithographic operation, the shot time calculating portion 15 of the hardware data routing system 10 for normal lithography calculates the shot time from the proximity effect correction amount map 18 according to the shot electron beam position on the workpiece. Where the beam spot size is larger than each microscopic region (partition) of the stored energy distribution map 69 (i.e., where the spot size spans plural microscopic regions), the amount of electron energy stored in the microscopic region (partition) containing the center of the beam spot is regarded as effective for shots of the electron beam. The shot time obtained in this way is applied to each shot of the beam and thus the pattern is delineated lithographically.

As described previously, a data processing operation for proximity effect correction and a normal lithographic data processing operation are performed in parallel for each lithographic field and repeatedly. These operations are carried out in parallel and in a pipelined manner such that the time taken to create a proximity effect correction amount map for one field is hidden by the time normally taken to perform normal lithographic processing.

With respect to lithographic field data used for subsequent lithography, the stored energy distribution maps of nearby fields created when the stored energy distribution map 69 for the previous lithographic field are created are saved for a time and exploited. Only with respect to lithographic field data for which any stored energy distribution maps of fields including adjacent fields are not saved, processing including creation of a stored energy distribution map is performed. When a proximity effect correction amount map for one lithographic field has been prepared, the map is utilized and one lithographic field of pattern is delineated while correcting the shot time of the electron beam for each microscopic region (partition).

One known apparatus of this kind (as disclosed, for example, in JP-A-2006-237396 (paragraphs 0016-0021, FIG. 1)) operates to classify plural elements of a pattern arranged within a region of interest according to their positions, to search for pattern elements adjacent to the sides of the pattern elements using the classified pattern elements to obtain information about the adjacent pattern elements, then to hierarchically divide the region of interest and register the pattern elements, to calculate the intensity of backward scattering at each evaluation point on the pattern by the use of information about the registered pattern elements, to evaluate the sum of the forward scattering intensity and backward scattering intensity at each evaluation point through the use of the information about the adjacent pattern elements and the obtained backward scattering intensities, to calculate the amount of motion of each pattern element, and to cause the sides to move a distance equal to the calculated amount of motion, thus modifying the geometry of the pattern.

A known electron beam exposure method as disclosed, for example, in JP-A-58-43516 (from page 2, right lower column, line 13 to page 3, right lower column, line 19 and FIGS. 1-5) consists of finding pattern dimensions that have been corrected to smaller dimensions while taking account of the influences among pattern elements due to electron beam scattering when the independent pattern elements are delineated at a constant density of impinging electron beam current under the presence of a target exposure pattern, then determining the beam current density for each independent pattern element when the independent pattern elements are delineated according to the sizes of the corrected smaller pattern element dimensions, and delineating the pattern with the above-described pattern dimensions and beam current density.

In the related art, only the influence of a proximity effect due to backward scattering of charged particles is noticed, and the influence of a proximity effect due to forward scattering is neglected, for the following reason. The range of influence of a proximity effect due to forward scattering is much smaller than in the case of backward scattering. Obviously, at actual spacings between adjacent device pattern elements, the dimensions of the finished lithography pattern and positional accuracy are not affected so much. Furthermore, by neglecting the influence of a proximity effect due to forward scattering, the size of tiny regions (partitions) used to estimate the influence of the proximity effect can be roughened to about 1/10 to 1/20 of the diameter of the backscattering region. The cost of equipment installed when a proximity effect correcting function is incorporated in a lithography system can be curtailed. Also, there is the advantage that the performance associated with calculations of amounts of correction is prevented from deteriorating.

However, in some modern device patterns with high device densities, the spacing between adjacent pattern elements is as small as approximately 2 to 3 times the diameter of the forward scattering region. If the influence of a proximity effect due to forward scattering is neglected in this portion, it is expected that the dimensions of the finished lithography pattern or positional accuracy will deteriorate.

In particular, as shown in FIG. 21, forward scattering of a charged-particle beam for delineating adjacent pattern elements affects the charged-particle energies stored in the mutual pattern elements. Especially, in locations where such pattern elements are adjacent to each other, the charged-particle energies stored in both pattern elements increase. As a result, pattern elements formed after a process such as development or etching increase in size compared with pattern elements indicated by the original pattern data or their spacing decreases ((2) of FIG. 21). Alternatively, the pattern elements are joined together ((3) of FIG. 21).

FIG. 21 illustrates the influence of a proximity effect due to forward scattering on adjacent pattern elements. The horizontal axis indicates position, while the vertical axis indicates charged-particle energy. In case (1), pattern elements are sufficiently spaced apart. The formed pattern elements have a linewidth (a) of process level L. In case (2), pattern elements are adjacent to each other and spaced at an interval of b. In this case, the delineated pattern elements are spaced at an interval of b′.

The line spacings b′ and b have the relationship b′<b. Linewidths have the relationship a<a+. (3) indicates a case where pattern elements are adjacent to each other. The formed pattern indicates that both elements are coupled together. That is, there is a space of c at the energy peak. In the formed pattern, the gap c′ is 0. (4) indicates a case in which pattern elements are in contact with each other. The formed pattern element has a width of 2a obtained by summing up their linewidths a.

### SUMMARY OF THE INVENTION

In view of these problems, the present invention has been made. It is an object of the invention to provide a charged-particle beam lithographic apparatus which is free of the foregoing problems and which can accurately delineate patterns faithfully to the original pattern data.

To solve the foregoing problems, the invention is configured as follows.

(1) A first embodiment of the present invention provides a lithographic method implemented by a charged-particle beam lithographic apparatus to delineate a pattern on a material surface by irradiating resist applied on the material surface by successive shots of a variably shaped charged-particle beam while varying shot times for which the beam is shot based on proximity effect corrective values previously found computationally. This method starts with estimating a distribution of magnitudes of absorption energy given to the resist by forward scattering of the beam regarding regions between each shot of interest and shots adjacent thereto. Then, a range in which the magnitudes of the absorption energy are in excess of an energy level necessary for a process (such as development and etching of the resist) is judged. Based on the results of the judgment, corrective shot data is found by translating sides of the shot of interest located opposite to the adjacent shots. Based on the corrective shot data, corrective values for a proximity effect produced under influence of backward scattering are calculated. The shots of the beam are carried out based on the corrective shot data and on the corrective values.

(2) A second embodiment of the present invention provides a lithographic method implemented by a charged-particle beam lithographic apparatus to delineate a pattern on a material surface by irradiating resist applied on a material surface by successive shots of a variably shaped charged-particle beam while varying shot times for which the beam is shot based on proximity effect corrective values previously found computationally. This method starts with drawing up a data table indicating relations of distances from each shot of interest to shots adjacent to the shot of interest to corresponding amounts of correction applied to a side of the shot of interest. Corrective shot data is found from the table by translating sides of the shot of interest located opposite to the adjacent shots. Corrective values for a proximity effect produced under influence of backward scattering are calculated based on the corrective shot data. The shots of the beam are carried out based on the corrective shot data and on the corrective values.

(3) A third embodiment of the invention is based on the first or second embodiment and further characterized in that with respect to each surrounding shot adjacent to each shot of interest, a shot at a minimum distance from the shot of interest is found from the surrounding shots in a direction perpendicular to a range extending from a starting point to an ending point of each of the upper, lower, left, and right sides of the shot of interest. The shot found to be minimally spaced from the shot of interest is defined to be adjacent to the shot of interest.

(4) A fourth embodiment of the invention is based on the first or second embodiment and further characterized in that data about shots in an area delineated by the charged-particle beam are stored in a shot data memory having a storage region divided into a matrix of storage blocks. The storage blocks are searched for shots adjacent to any one of the upper, lower, left, and right sides of each shot of interest in a direction perpendicular to a range extending from a starting point to an ending point of the shot of interest. The shot found to be at a minimum distance from any of the sides of the shot of interest is defined to be adjacent to the shot of interest.

(5) A fifth embodiment of the invention is based on the third or fourth embodiment and further characterized in that in a case where the minimum distance from each shot of interest to the adjacent shots is zero or in a case where the minimum distance is such that the adjacent shots are not affected by a proximity effect due to forward scattering, the positions of the sides of the shot of interest located opposite to its adjacent shots are not corrected.

(6) A sixth embodiment of the invention provides a charged-particle beam lithographic apparatus for delineating a pattern on a material surface by irradiating resist applied on the material surface by successive shots of a variably shaped charged-particle beam while varying times for which the beam is shot based on proximity effect corrective values previously found computationally. The apparatus has a computing means and a beam shooting means. The computing means estimates a distribution of magnitudes of absorption energy given to the resist due to forward scattering of the beam according to regions between each shot of interest and shots adjacent thereto, judges a range in which the magnitudes of the absorption energy are in excess of an energy level necessary for a process such as development and etching of the resist, and creates corrective shot data about corrected shots by translating sides of the shot of interest located opposite to the adjacent shots based on results of the judgment. The beam shooting means calculates corrective values for a proximity effect produced under influence of backward scattering based on the corrective shot data and carries out the shots of the beam based on the corrective shot data and on the corrective values.

(7) A seventh embodiment of the invention is based on the sixth embodiment and further characterized in that the computing means has a data table indicating relations of distances to the adjacent shots to corresponding amounts of correction applied to the sides and creates the corrective shot data by reading the amounts of correction applied to the sides according to the distances to the adjacent shots from the table.

(8) An eighth embodiment of the invention is based on the sixth embodiment and further characterized in that the beam shooting means includes blanking means for controlling shot times for which the charged-particle beam is shot based on the calculated proximity effect corrective values, shaped deflection means for determining the size of the shaped charged-particle beam based on the corrective shot data, and position deflecting means for determining positions of the shaped charged-particle beam on the material surface based on the corrective shot data.

The present invention yields the following advantageous effects.

(1) According to the first embodiment of the invention, the corrective shot data is found by translating the sides of each shot of interest located opposite to the adjacent shots based the results of the judgment. The corrective values for the proximity effect produced under influence of backward scattering are calculated based on the corrective shot data. The shots of the beam are carried out based on the corrective shot data and the corrective values. Consequently, the pattern can be delineated accurately and faithfully to the original pattern data.

(2) According to the second embodiment of the invention, there is the data table indicating the relations between the amounts of correction applied to the sides and the distances to the adjacent shots. The corrective shot data which has been obtained by translating the sides of each shot of interest located opposite to the adjacent shots are found from the table. The corrective values for the proximity effect produced under influence of backward scattering are calculated based on the corrective shot data. The shots of the beam are carried out based on the corrective shot data and on the corrective values. Therefore, the pattern can be delineated accurately and faithfully to the original pattern data.

(3) According to the third embodiment of the invention, a shot at a minimum distance from the shot of interest is found from the surrounding shots in a direction perpendicular to a range extending from a starting point to an ending point of each of the upper, lower, left, and right sides of the shot of interest. The shot found to be minimally spaced from the shot of interest is defined to be adjacent to the shot of interest. In consequence, an accurate pattern delineation can be performed.

(4) According to the fourth embodiment of the invention, data about shots in the lithographic region to be written with the charged-particle beam are stored in the shot data memory having the storage region divided into the matrix of storage blocks. The storage blocks are searched for shots adjacent to any one of the upper, lower, left, and right sides of each shot of interest in a direction perpendicular to a range extending from a starting point to an ending point of each side of the shot of interest. The shot found to be at a minimum distance from each side of the shot of interest is defined to be adjacent to the shot of interest. Hence, an accurate pattern delineation can be performed.

(5) According to the fifth embodiment of the invention, in a case where the minimum distance of each shot of interest to the adjacent shot is zero or in a case where the minimum distance is such that the adjacent shot is not affected by a proximity effect due to forward scattering, the pattern can be delineated accurately without correcting the position of the shot of interest located opposite to the adjacent shot.

(6) According to the sixth embodiment of the invention, the corrective shot data is found by translating the sides of each shot of interest located opposite to the adjacent shots based on the results of judgment. The corrective values for a proximity effect produced under influence of backward scattering are calculated based on the corrective shot data. The shots of the beam are carried out based on the corrective shot data and on the corrective data. Consequently, the pattern can be delineated accurately and faithfully to the original pattern data.

(7) According to the seventh embodiment of the invention, the computing means has the data table indicating the relations between amounts of correction applied to the sides and distances to the adjacent shots. The computing means reads amounts of correction applied to the sides according to the distances to the adjacent shots from the table and creates the corrective shot data. Therefore, the pattern can be delineated accurately.

(8) According to the eighth embodiment of the invention, the beam shooting means includes the blanking means for controlling shot times of the charged-particle beam based on the calculated proximity effect corrective values, the shaped deflection means for determining the size of the shaped charged-particle beam based on the corrected shot data, and the position deflecting means for determining the positions of the shaped charged-particle beam on the material surface based on the corrective shot data. Consequently, the pattern can be delineated accurately.

Other objects and features of the invention will appear in the course of the description thereof, which follows.

### BRIEF DESCRIPTION OF THE DRAWINGS

FIGS. 1A-1C are views illustrating a proximity effect due to forward scattering and a method of correcting the effect;

FIG. 2 is a block diagram illustrating one embodiment of the present invention;

FIG. 3 is a block diagram showing a specific example of configuration of a pattern data routing system;

FIG. 4 is a block diagram showing an example of configuration of a hardware data routing system for proximity effect correction;

FIGS. 5A-5C illustrate adjacent shots;

FIGS. 6A-6C illustrate the manner in which shot sides are corrected;

FIG. 7 is a conceptual view illustrating the manner in which data about shots is written into a shot data memory;

FIG. 8 illustrates a method of searching for adjacent shots;

FIG. 9 illustrates energy distributions produced on occurrence of forward scattering and backward scattering, respectively;

FIG. 10 illustrates the influence of a proximity effect on a pattern linewidth after a development process;

FIG. 11 shows an example of pattern data;

FIG. 12 shows an example of energy distribution reference table;

FIG. 13 shows an example of stored energy distribution map;

FIG. 14 shows an example of stored energy conversion table;

FIGS. 15A and 15B are diagrams illustrating a shot time correction;

FIG. 16 shows an example of proximity effect correction amount map;

FIGS. 17A and 17B are diagrams showing the results of a computational correction and the results of an actual correction;

FIG. 18 is a graph showing an example of stored energy conversion table;

FIGS. 19A and 19B are diagrams illustrating a shot time correction;

FIG. 20 is a block diagram showing an example of configuration of a related art system; and

FIG. 21 illustrates the influence of a proximity effect due to forward scattering on adjacent pattern elements.

### DESCRIPTION OF THE PREFERRED EMBODIMENTS

Embodiments of the present invention are hereinafter described in detail with reference to the drawings.

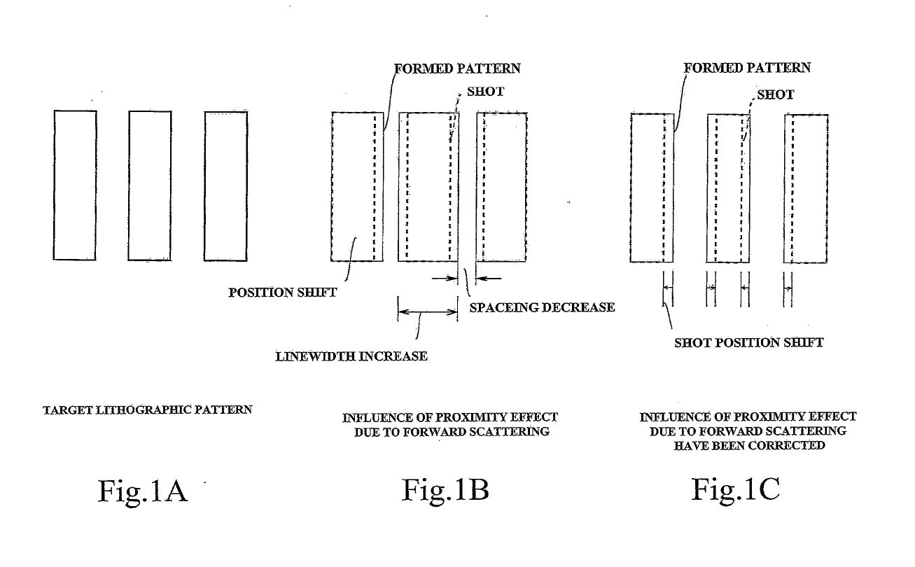

FIGS. 1A-1C illustrate a proximity effect due to forward scattering and a method of correcting the effect. FIG. 1A shows a target lithographic pattern. FIG. 1B illustrates the influence of the proximity effect due to forward scattering. FIG. 1C illustrates the state in which the influence of the proximity effect due to forward scattering has been corrected. As shown in FIG. 1A, the target lithographic pattern consists of an array of three rectangles. If lithography is performed exactly according to the target pattern, the rectangles in the resulting pattern are so deformed that sides located opposite to each other approach each other. Therefore, in the formed pattern, the rectangles have increased width. In particular, as shown in FIG. 1B, if lithography is performed with shots of beam as indicated by the broken lines, the rectangles on both sides increase in width toward the inside. The central rectangle increases in width toward the left and right sides.

Therefore, the spacings between the rectangles decrease. The central positions of the rectangles on both sides shift inwardly. In contrast, according to the inventive correction of a proximity effect due to forward scattering, the sides of the rectangles are moved away from each other taking account of increases in width due to approach of the sides toward each other, whereby their width is made smaller as indicated by the dotted lines in FIG. 1C than in the case of FIG. 1A. Lithography is performed with shots of beam according to the rectangles of reduced width. Consequently, the formed pattern is faithful to the target lithographic pattern shown in FIG. 1A.

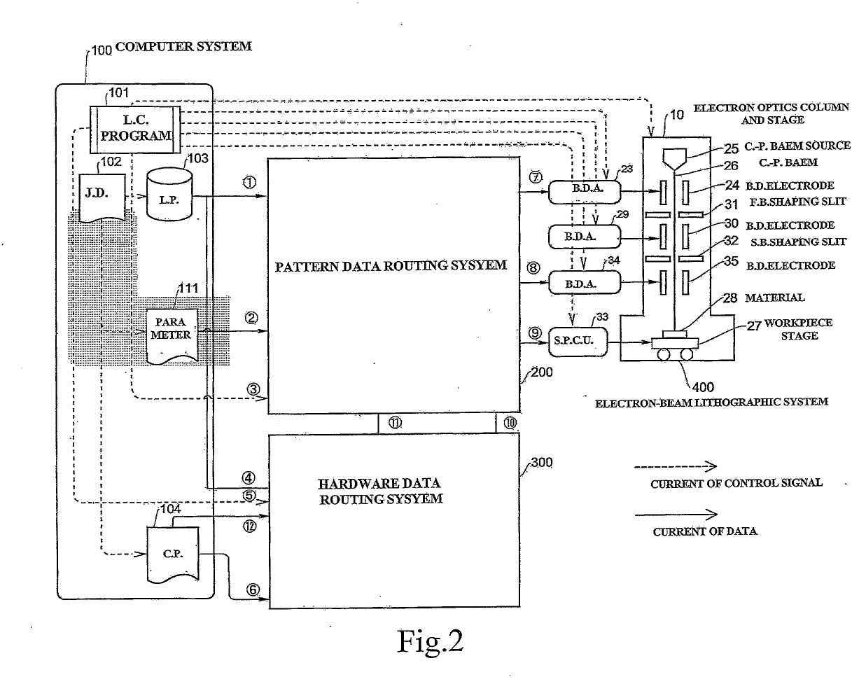

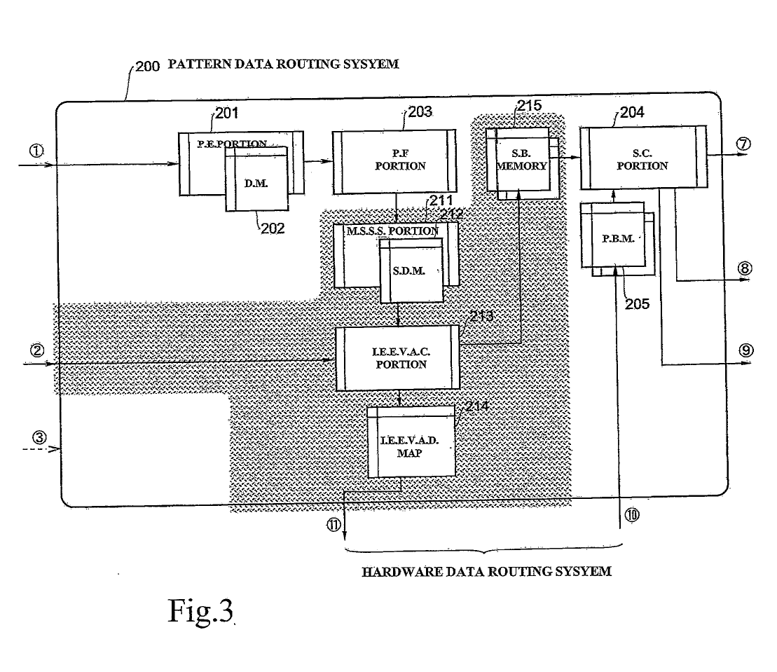

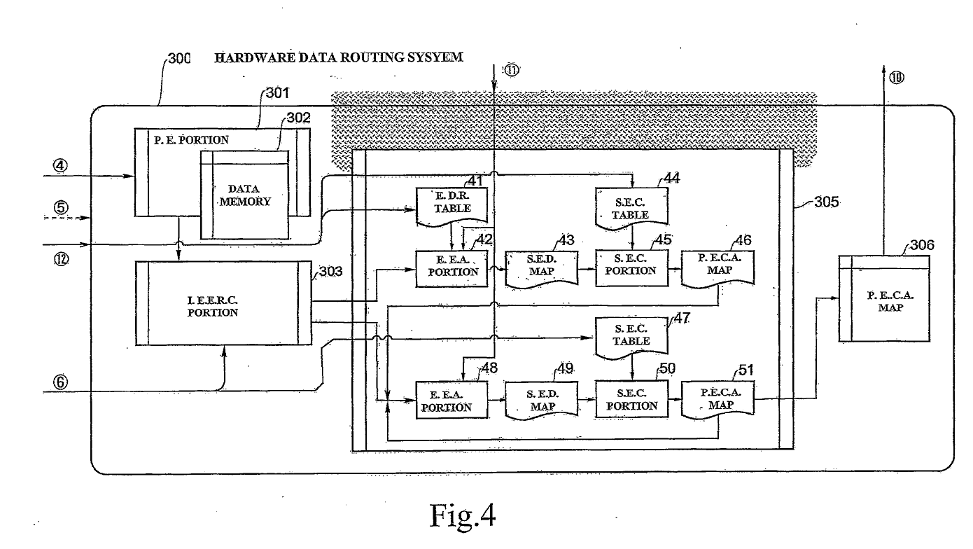

An example of configuration of an electron beam lithography system acting as a charged-particle beam lithographic apparatus to which the present invention is applied is shown in FIGS. 2-4. FIG. 2 is a block diagram showing one example of apparatus according to the invention. FIG. 3 is a diagram showing the details of the configuration of a pattern data routing system. FIG. 4 is a block diagram showing the details of the configuration of a hardware data routing system for proximity effect correction.

Referring to FIG. 2, there are shown a computer system 100 for lithography control, a pattern data routing system 200, a hardware data routing system 300 for proximity effect correction, and an electron-beam lithographic system 400. The computer system 100 includes a lithography control program 101, a job deck 102, a lithographic pattern 103, a parameter 111 for correcting a proximity effect due to forward scattering, and a corrective parameter 104 for correcting a proximity effect due to backward scattering. Indicated by 10 is an electron optics column and stage. Also shown are a beam deflection amplifier 23 for control of shot times, a beam deflection amplifier 29 for controlling the shot size, a beam deflection amplifier 34 for controlling the shot position, and a stage position controlling unit 33.

Referring to FIG. 3, the pattern data routing system 200 includes a pattern expansion portion 201, a data memory 202, a pattern fracturing portion 203, a minimally spaced shot searching portion 211, a shot data memory 212, a shot side position correcting portion (incident electron energy variation amount calculating portion) 213, an incident electron energy variation amount distribution map 214, a shot buffer memory 215, a shot control portion 204, and a PEC (proximity effect correction) buffer memory 205.

Referring to FIG. 4, the hardware data routing system 300 for proximity effect correction is configured including a pattern expansion portion 301, a data memory 302, an incident electron energy ratio calculating portion 303, and a proximity effect correction amount calculating portion 305.

The proximity effect correction amount calculating portion 305 is configured including an energy distribution reference table 41, an electron energy accumulator portion 42, a stored energy distribution map 43, a stored energy conversion table 44 for an initial calculation, a stored energy conversion portion 45, a proximity effect correction amount map 46 for the initial calculation, a stored energy conversion table 47 for a recalculation, an electron energy accumulator portion 48, a stored energy distribution map 49, a stored energy converter portion 50, and a proximity effect correction amount map 51 for recalculation. The hardware data routing system 300 for proximity effect correction has a proximity effect correction amount map 306. In these figures, some signal lines indicate flow of control signals by dotted lines and the other signal lines indicate flow of data by solid lines.

Referring again to FIG. 2, in the computer system 100 for lithographic control, the lithography control program 101 operates to control the operation of the whole lithography system. The computer system 100 has a storage device in which the job deck 102 describing the layout of the lithographic pattern and lithographic conditions, the lithographic pattern 103 to be written, the corrective parameter 104 for correcting a proximity effect due to backward scattering, and the parameter 111 for correcting a proximity effect due to forward scattering are stored. The corrective parameter 104 describes a control parameter for correcting the proximity effect.

Referring again to FIG. 3, the pattern data routing system 200 has the pattern expansion unit 201 including the data memory 202 for temporarily storing the lithographic pattern 103, the pattern fracturing portion 203 for fracturing the pattern into shots, and the minimally spaced shot searching portion 211 including the shot data memory 212 for temporarily storing data about the shots. The searching portion 211 measures the distances among the shots and searches for a shot at a minimum distance. The routing system 200 further includes the shot side position correcting portion 213 for translating the positions of the sides of the shots according to the distances among the shots, outputting the results to the shot buffer memory 215, and outputting the incident electron energy variation amount distribution map 214 indicating a distribution of the rates of variation of the incident electron energy caused by the translation of the positions of the sides of the shots, and the shot control portion 204. The proximity effect correction amount map created by the hardware data routing system 300 for proximity effect correction is temporarily stored in the PEC buffer memory 205. The shot control portion 204 creates shots based on the shot data read from the shot buffer memory 215 and on the shot time modulation amount read from the PEC buffer memory 205 and corrects the shot times.

Referring again to FIG. 4, the hardware data routing system 300 for proximity effect correction is configured including the pattern expansion portion 301 having the data memory 302 for temporarily storing the pattern 103, the incident electron energy ratio calculating portion 303 for estimating the ratio of incident electron energy for each partition, an incident electron energy distribution map 304 for storing the estimated ratio of the incident electron amount, and the proximity effect correction amount calculating portion 305 for calculating the proximity effect correction amount map 306 in which proximity effect correction amount data for each partition in each lithographic field is stored.

Referring back to FIG. 2, the electron optics column and stage 10 is made up of a charged-particle beam source 25 producing a charge-particle beam (such as an electron beam) 26, beam deflection electrodes 24, 30, 35, a first beam shaping slit 31, a second beam shaping slit 32, and a workpiece stage 27 carrying a workpiece or material 28 to be written thereon to move the material. The system is configured as shown in FIGS. 2-4. The operation of the system configured as described so far is described below.

The lithography control program 101 controls various processing tools equipped to the lithography system according to the layout, lithography conditions, and so on described in the job deck 102 and to cause the processing tools to carry out the following processing steps. When lithography is started, the lithography control program 101 sends the data about the pattern 103, in compressed form, described in the job deck 102 from a disk (storage device) in the computer system 100 for lithographic control to the data memory 202 of the pattern data routing system 200.

The pattern expansion portion 201 of the pattern data routing system 200 reads pattern data about one lithographic field from the data memory 202 at the timing of lithography, expands the compressed data to create a rectangular or trapezoidal pattern, and sends it to the pattern fracturing portion 203. The fracturing portion 203 fractures the pattern into rectangular shots of a size equal to the size of the writing charged-particle beam. Each rectangular shot is made up of four sides parallel to any one of the X and Y coordinate axes that are orthogonal to each other. Data about these shots are once stored in the shot data memory 212.

The minimally spaced shot searching portion 211 takes notice of data about each individual shot stored in the shot data memory 212. The searching portion 211 searches for shots each having a side that faces any one of the upper, lower, left, and right sides of each surrounding shot adjacent to each shot of interest, and finds the distances among the shots.

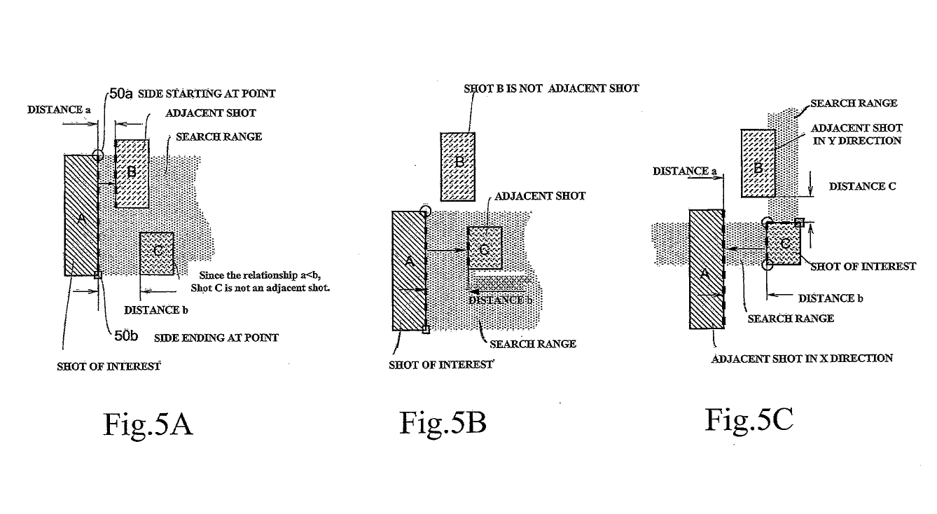

A search range is in a direction perpendicular to a range going from the starting point to the ending point of each side forming the shot of interest. Within this search range, a shot having a side that is parallel to, and at a minimum distance from, that side is taken as an adjacent shot. FIGS. 5A-5C show adjacent shots in three cases. In FIG. 5A, a shot of interest is indicated by A and has a side starting at point 50a (o) and ending at point 50b (o). An adjacent shot referred to herein is defined as a shot having a side that is parallel to, and minimally spaced from, a side of a shot of interest within a search range lying in a direction perpendicular to a range going from the starting point to the ending point of each side forming the shot of interest. That is, with respect to each shot of interest having four sides (upper, lower, left, and right sides), shots having sides each disposed opposite to any one of the upper, lower, left, and right sides of the shot of interest and minimally spaced from the shot of interest are searched for and defined as adjacent shots. Therefore, in FIG. 5A, the shot B is an adjacent shot. In this case, let a be the distance from the shot A to the adjacent shot B. This pattern also includes a shot C. The distance from the shot C to the shot A of interest is b. Since the relationship, a<b, holds, the shot C is not an adjacent shot.

FIG. 5B is now described. In this figure, a shot C is an adjacent shot. A shot B is also close to a shot A of interest but is contiguous to the shot A in a nonperpendicular direction. Therefore, the shot B is not an adjacent shot.

FIG. 5C is now described. In this figure, a shot B is adjacent to, and at a distance of c from, the upper side of a shot C of interest. On the other hand, a shot A is adjacent to, and at a distance of b from, the left side of the shot C of interest. The search range can be restricted to a range where the influence of a proximity effect due to forward scattering is exerted and so the whole pattern to be written is divided into subranges of size which can cover the influence of the proximity effect due to forward scattering. The position of each shot is assigned to any of the subranges, and data about each shot is stored at a corresponding location in the shot data memory.

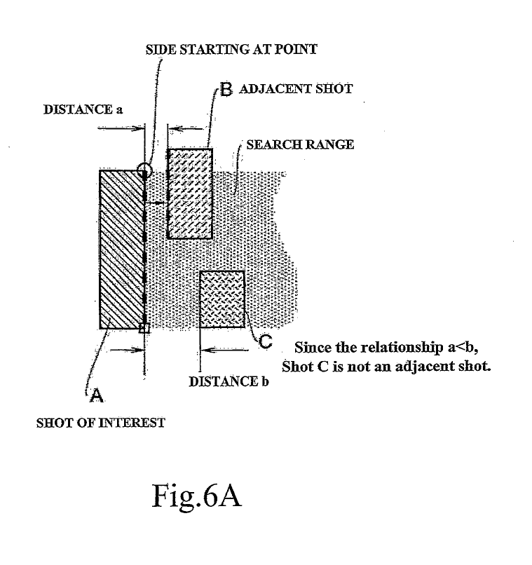

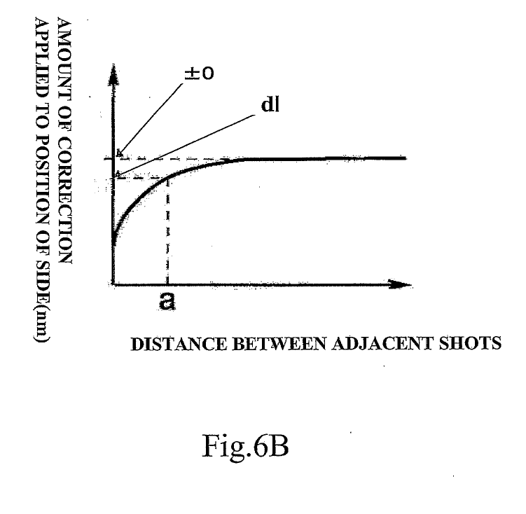

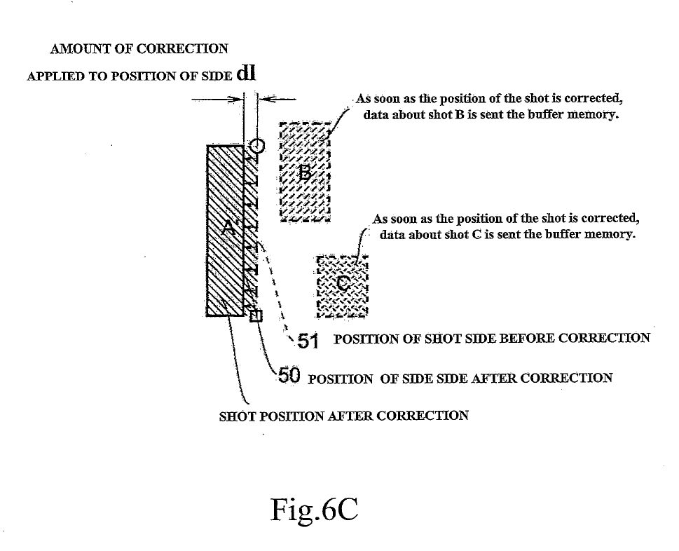

FIGS. 6A-6C illustrate a method of correcting shot positions. FIG. 6A shows shot data stored in the shot data memory. FIG. 6B shows a parameter. FIG. 6C shows shot data stored in a buffer memory. In FIG. 6A, shots B and C are present around a shot A of interest. Because the distance a between the shots A and B is smaller than the distance b between the shots A and C, the shot B is taken as an adjacent shot.

FIG. 6B shows an amount of correction applied to the position of a side. The horizontal axis indicates the distance between adjacent shots. The vertical axis indicates the amount of correction applied to the position of the side. The parameter shows the amount of correction applied to the position of one side of a shot relative to the distance between the adjacent shots. In the illustrated example, since the distance between the adjacent shots is a, the characteristic curve assumes a value of dl. Where the distance between the adjacent shots is 0 or where the minimum distance to the adjacent shot is such that the shot is not affected by a proximity effect due to forward scattering, the amount of correction applied to the position of the side of the shot is set to ±0 nm.

FIG. 6C illustrates the manner in which the position of a side is corrected. The amount of correction applied to the position of the shot A is dl as shown in FIG. 6B. The position 51 of the side of the shot is shifted by the amount dl into position 50 by the correction. As soon as the position of the shot is corrected (the corrected shot is indicated by N), data about the shots B and C are sent to the buffer memory. Corrective data shown in FIG. 6B used to correct the position of the side of the shot has been previously obtained by measurements.

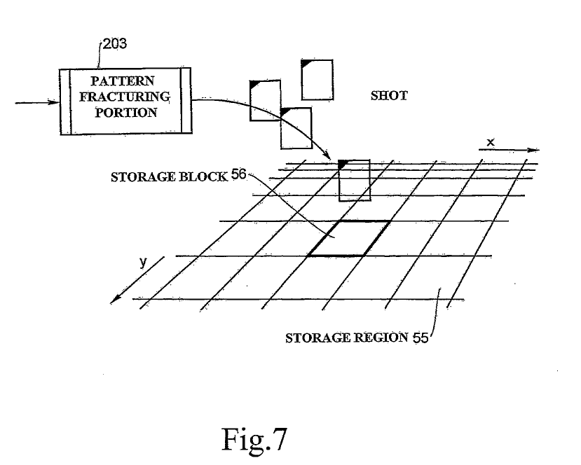

FIG. 7 is a conceptual view illustrating the manner in which pattern data from the pattern fracturing portion 203 represent shots of each shot size and are stored in the shot data memory 212. The storage region 55 within the shot data memory 212 is divided into a matrix of storage blocks 56 corresponding to sections of the area to be delineated by a charged-particle beam. The pattern fracturing portion 203 reads out data about the shots stored in the individual storage blocks 56 and performs shots of the beam. Thus, with respect to each shot of interest, adjacent shots affected by a proximity effect due to forward scattering can be found in most cases by searching one storage block 56 in which the data about the shot is stored.

With respect to shots whose data are located at fringes of one storage block 56, there is the possibility that data about adjacent shots might be present outside this storage block. Therefore, adjacent storage blocks are also searched, as well as that storage block.

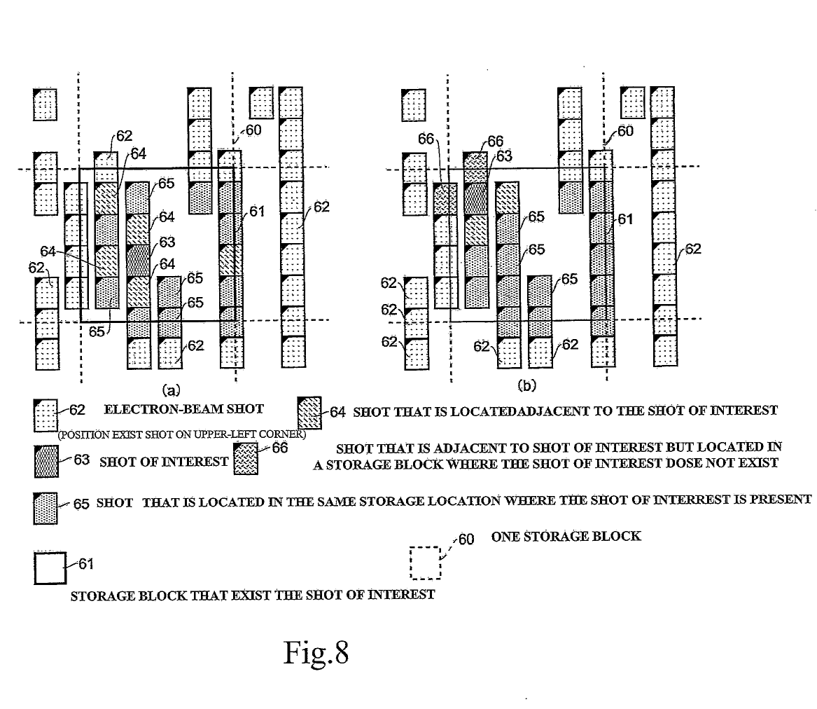

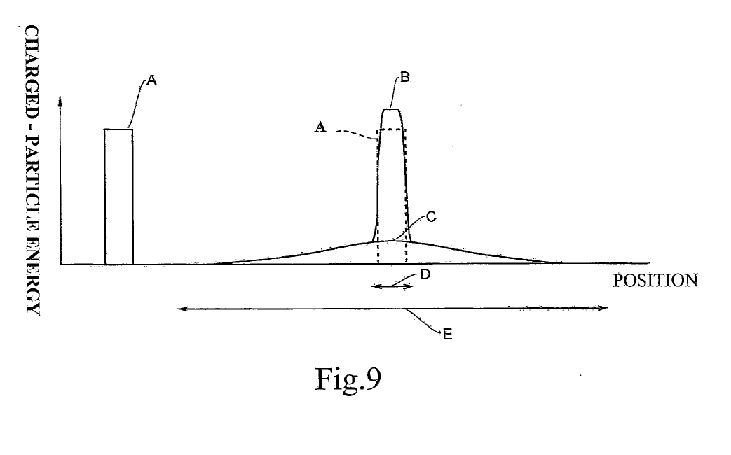

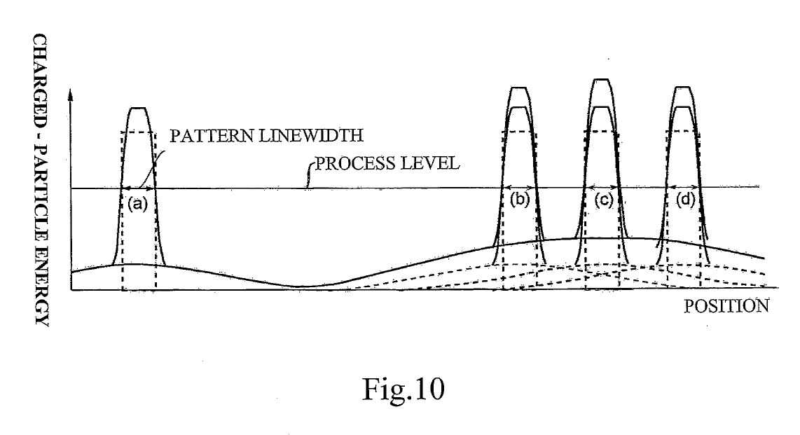

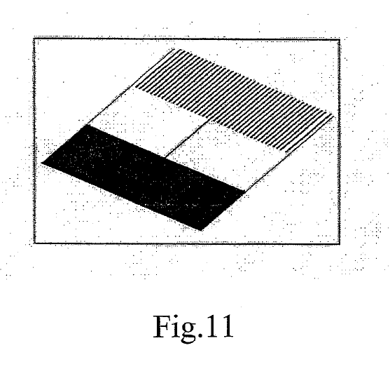

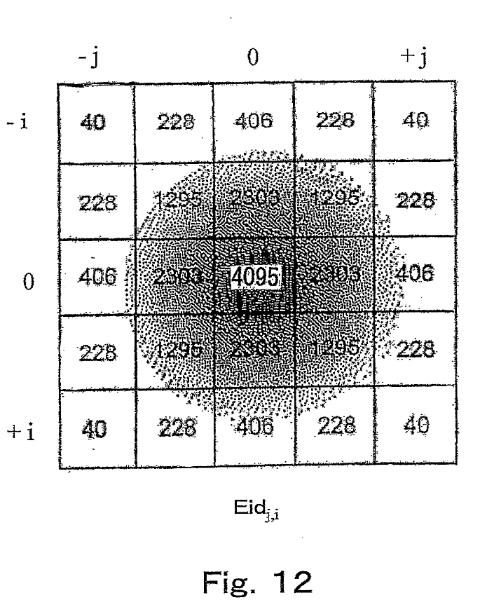

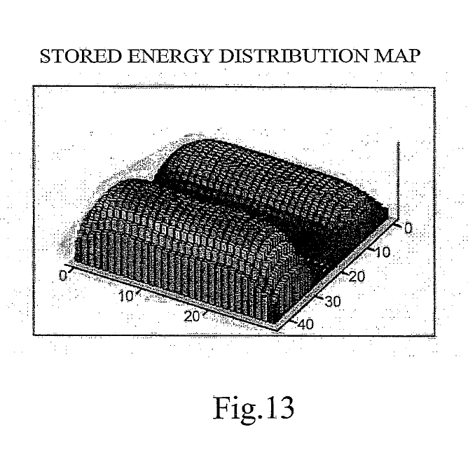

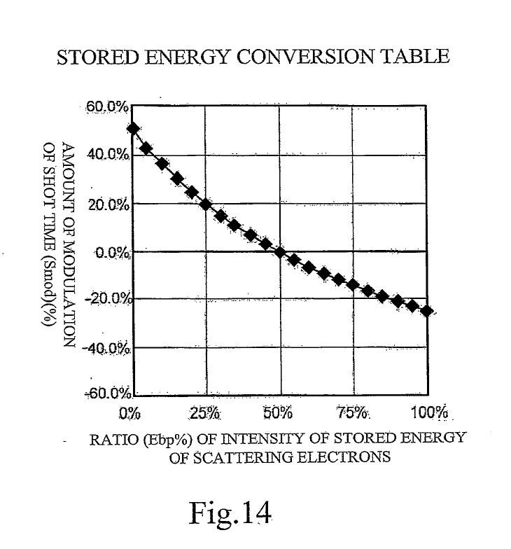

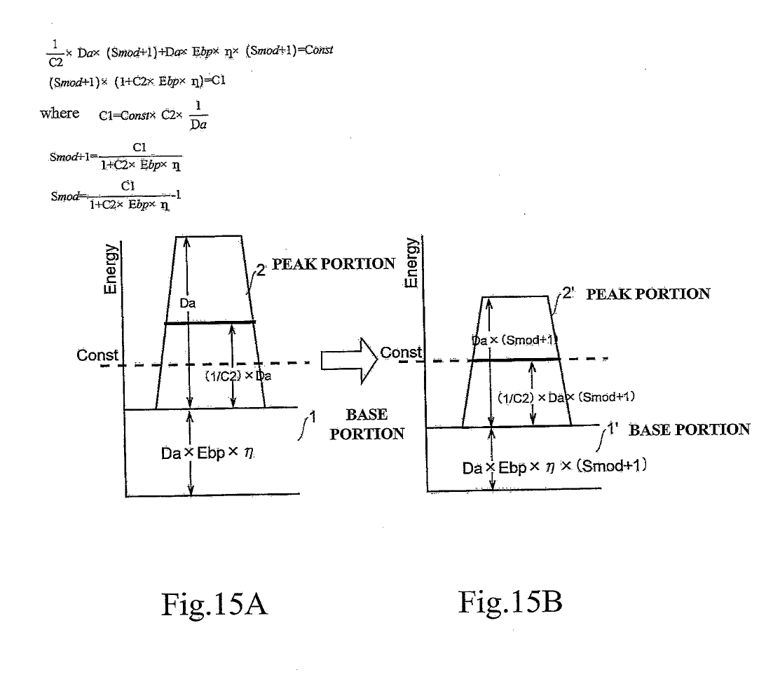

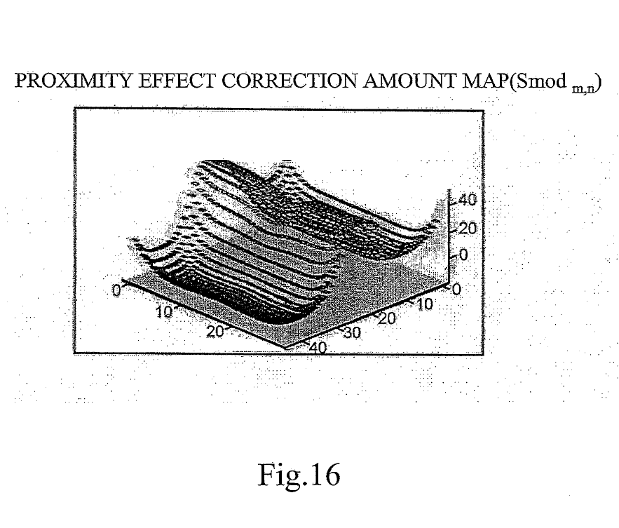

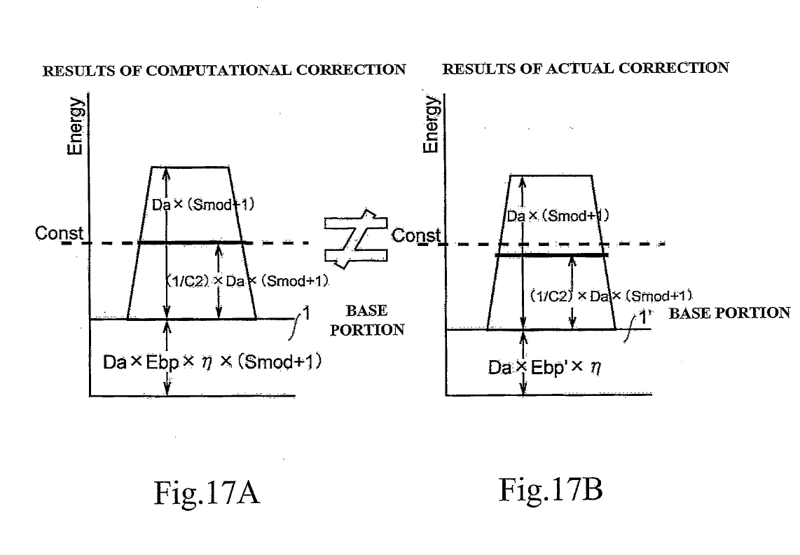

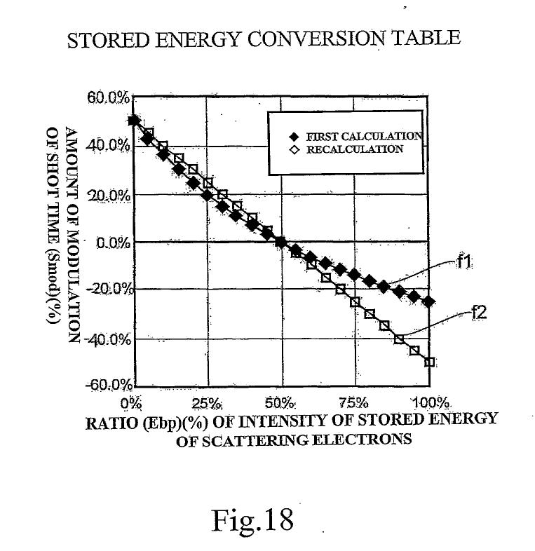

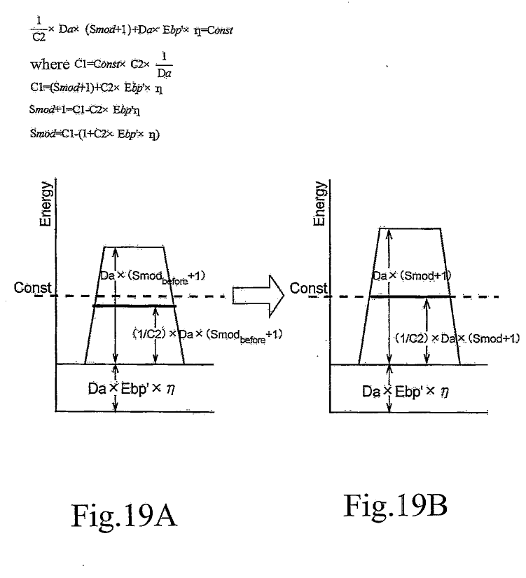

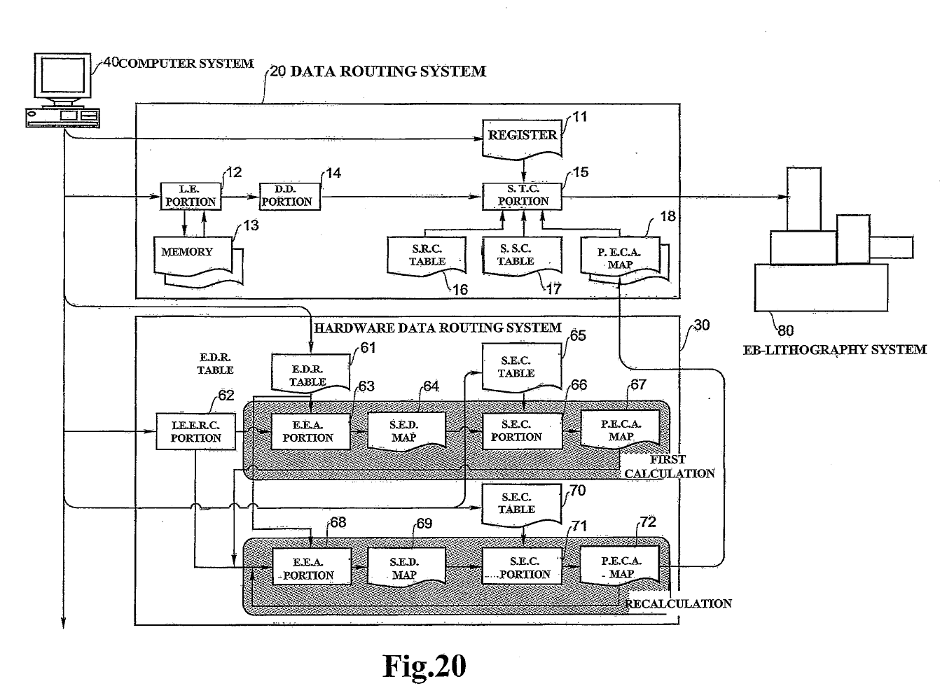

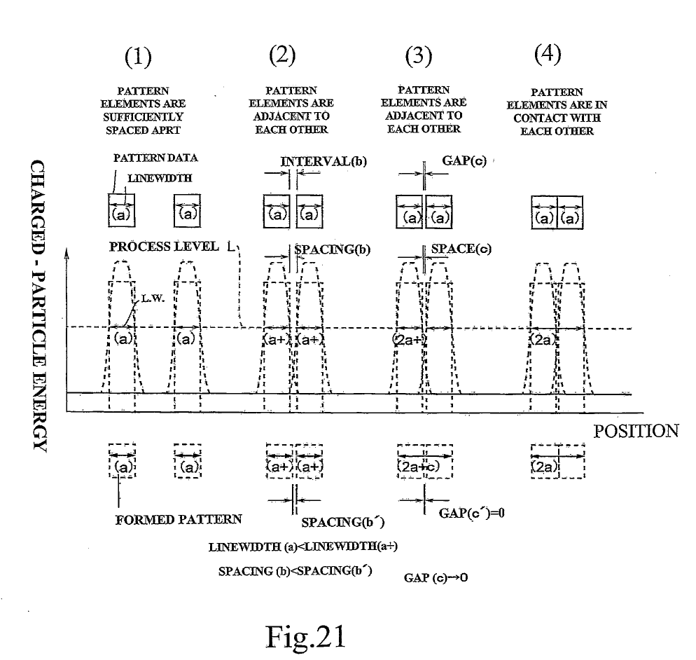

FIG. 8 illustrates a method of searching adjacent shots, showing two cases (a) and (b). Indicated by 60 is each one storage block. Data about a shot of interest is present in a storage block 61 that is equivalent to the storage block 56 shown in FIG. 7. Indicated by 62 are shots written with an electron beam. There is a shot of interest 63. Shots 64 are adjacent to the shot of interest. Shots 65 are located in the same storage location where the shot of interest is present. A shot 66 is adjacent to the shot of interest but located in a storage block where the shot of interest does not exist.

Referring back to FIG. 3, the shot side position correcting portion 213 creates a modified shot from a shot of interest by modifying its position and size according to the relations of the distances to neighboring shots whose data have been previously stored as the parameter 111 on a disk placed in the lithography controlling computer system 100 to the amounts of correction applied to the position of one side of each shot located opposite to the shot of interest, sending data about the modified shot to the shot buffer memory 215, calculating the ratios of the variations in the incident electron energy brought about by the creation of the modified shot, and using the calculated ratios as the incident electron energy variation amount map 214 per partition for estimating the influence of the proximity effect due to backward scattering. The pattern data routing system 200 sends the calculated map to the hardware data routing system 300 for proximity effect correction (as indicated by 11 surrounded by a small circle in FIGS. 2, 3, and 4).

The parameters indicating the relations of the distances to the neighboring shots to the amounts of correction applied to the position of one opposite side of each shot located opposite to the shot of interest include a parameter applied to the case where the distances to the neighboring shots are null. In this case, the neighboring shots are in intimate contact with the shot of interest and, therefore, the amount of correction applied to the position of one side of such a neighboring shot is defined to be zero. Under normal circumstances, it is necessary to correct the position of one side of a shot of interest as well as the position of one side of a shot adjacent to the shot of interest. Conversely, where the adjacent shot is noticed, the shot that has been noticed thus far is not always adjacent to that shot. Accordingly, only the position of one side of the currently noticed shot is corrected by translating the position the amount of correction for one side.

Furthermore, a shot of interest may be searched for as a shot adjacent to a succeeding shot by this succeeding shot. Therefore, no correction is made within the shot data memory, and the contents of the memory are kept intact. Data about a shot obtained by modifying the position and size of a shot of interest is sent to the shot buffer memory 215. In this way, all the shots are noticed, and the positions of the four sides of each shot are corrected.

In parallel with this processing, the hardware data routing system 300 for proximity effect correction creates a proximity effect correction amount map (distribution of amounts of modulation applied to shot times) 306 for proximity effect correction by recalculating the corrective values for the proximity effect based on the incident electron energy variation amount map 214 sent in from the pattern data routing system 200 and sends the proximity effect correction amount map 306 for the aforementioned one lithographic unit to the PEC buffer memory 205 of the shot control portion 204 as indicated by numeral 10 surrounded by a small circle in FIGS. 3 and 4.

The positions of sides of shots are corrected to correct a proximity effect due to forward scattering as described previously. As a result, the ratios of the amounts of charged-particle energy incident on per partition to estimate the influence of the proximity effect due to backward scattering are changed. Therefore, the proximity effect due to backward scattering is corrected while taking account of the influence. Furthermore, the map 214 (FIG. 3) of distribution of rates of change of the incident electron energy amount varied by translation of the sides of the shots is created. Thus, the amounts of correction made for the proximity effect are calculated while correcting the ratios of incident electron energy.

The shot control portion 204 reads data about shots modified as described previously from the shot buffer memory 215, sets the shots at shot times based on the proximity effect correction amount map stored in the PEC buffer memory 205 according to the positions, and applies voltages to the beam deflection electrode 24 through the beam deflection amplifier 23 for controlling the shot times, thus controlling the times for which the lithographic material 28 held on the material moving stage 27 is irradiated with the electron beam 26 released from the charged-particle beam source 25.

In order to create a shot of modified size by means of the electron beam 26, a voltage is applied to the beam deflection electrode 30 via the beam deflection amplifier 29 for controlling the shot size based on the size of the geometric figure of the shot to deflect the beam 26 passing through the beam shaping slits 31 and 32, thus creating a shaped electron beam of desired size. In addition, the workpiece stage 27 for moving the workpiece or material is moved via the stage position controlling unit 33 according to the modified position of the shot, and a lithographic field is set within the deflection region of the beam 26. A voltage is applied to the beam deflection electrode 35 through the beam deflection amplifier 34 for control of the shot position to shoot the shaped electron beam at the desired position within the lithographic field.

The present invention produces the following advantageous effects.

A charged-particle beam lithographic apparatus has a data table indicating relations of the distances to shots adjacent to each shot of interest to corresponding amounts of correction applied to the positions of sides of the shot of interest when a pattern is delineated. Corrective shot data is found from the table by translating sides of the shot of interest located opposite to the adjacent shots. Based on the corrective shot data, corrective values for a proximity effect produced under the influence of backward scattering are calculated. Shots of the charged-particle beam are carried out based on the corrective shot data and on the corrective values. Thus, the influence of the proximity effect due to forward scattering is corrected. Consequently, a lithographic pattern having desired dimensions can be formed on a material or workpiece.

Having thus described my invention with the detail and particularity required by the Patent Laws, what is desired protected by Letters Patent is set forth in the following claims.

The invention claimed is:

1. A lithographic method implemented by a charged-particle beam lithographic apparatus to delineate a pattern on a material surface by irradiating resist applied on the material surface by successive shots of a variably shaped charged-particle beam while varying shot times for which the beam is shot based on proximity effect corrective values previously found computationally, said lithographic method comprising the steps of:
estimating a distribution of magnitudes of absorption energy given to the resist by forward scattering of the charged-particle beam regarding regions between each shot of interest and shots adjacent thereto;
judging a range in which the magnitudes of the absorption energy are in excess of an energy level necessary for a process such as development and etching of the resist;
finding corrective shot data by translating sides of the shot of interest located opposite to the adjacent shots based on results of the judgment;
calculating corrective values for a proximity effect produced under influence of backward scattering based on the corrective shot data; and
carrying out the shots of the beam based on the corrective shot data and on the corrective values.

2. A lithographic method implemented by a charged-particle beam lithographic apparatus to delineate a pattern on a material surface by irradiating resist applied on the material surface by successive shots of a variably shaped charged-particle beam while varying shot times for which the beam is shot based on proximity effect corrective values previously found computationally, said lithographic method comprising the steps of:
drawing up a data table indicating relations of distances from each shot of interest to shots adjacent to the shot of interest to corresponding amounts of corrections applied to a side of the shot of interest;
finding corrective shot data from the table by translating sides of the shot of interest located opposite to the adjacent shots;
calculating corrective values for a proximity effect produced under influence of backward scattering based on the corrective shot data; and
carrying out the shots of the beam based on the corrective shot data and on the corrective values.

3. A lithographic method implemented by a charged-particle beam lithographic apparatus as set forth in any one of claim 1 or 2, wherein with respect to each surrounding shot adjacent to each shot of interest, a shot at a minimum distance from the shot of interest is found from the surrounding shots in a direction perpendicular to a range extending from a starting point to an ending point of each of the upper, lower, left, and right sides of the shot of interest, and wherein the shot found to be minimally spaced from the shot of interest is defined to be adjacent to the shot of interest.

4. A lithographic method implemented by a charged-particle beam lithographic apparatus as set forth in any one of claim 1 or 2, wherein data about shots in an area delineated by the charged-particle beam are stored in a shot data memory having a storage region divided into a matrix of storage blocks, the storage blocks are searched for shots adjacent to any one of the upper, lower, left, and right sides of each shot of interest in a direction perpendicular to a range extending from a starting point to an ending point of each of upper, lower, left, and right sides of the shot of interest, and the shot found to be at a minimum distance from any of the sides of the shot of interest is defined to be adjacent to the shot of interest.

5. A lithographic method implemented by a charged-particle beam lithographic apparatus as set forth in claim 3, wherein in a case where the minimum distance from each shot of interest to the adjacent shots is zero or in a case where the minimum distance is such that the adjacent shots are not affected by a proximity effect due to forward scattering, the positions of the sides of the shot of interest located opposite to its adjacent shots are not corrected.

6. A lithographic method implemented by a charged-particle beam lithographic apparatus as set forth in claim 4, wherein in a case where the minimum distance from each shot of interest to the adjacent shots is zero or in a case where the minimum distance is such that the adjacent shots are not affected by a proximity effect due to forward scattering, the positions of the sides of the shot of interest located opposite to its adjacent shots are not corrected.

7. A charged-particle beam lithographic apparatus for delineating a pattern on a material surface by irradiating resist applied on the material surface by successive shots of a variably shaped charged-particle beam while varying shot times for which the beam is shot based on proximity effect corrective values previously found computationally, said apparatus comprising:
computing means for estimating a distribution of magnitudes of absorption energy given to the resist due to forward scattering of the beam according to regions between each shot of interest and shots adjacent thereto, judging a range in which the magnitudes of the absorption energy are in excess of an energy level necessary for a process such as development and etching of the resist, and creating corrective shot data about corrected shots by translating sides of the shot of interest located opposite to the adjacent shots based on results of the judgment; and
beam shooting means for calculating corrective values for a proximity effect produced under influence of backward scattering based on the corrective shot data and carrying out the shots of the beam based on the corrective shot data and on the corrective values.

8. A charged-particle beam lithographic apparatus as set forth in claim 7, wherein said computing means has a data table indicating relations of distances to the adjacent shots to corresponding amounts of correction applied to the sides and creates the corrective shot data by reading the amounts of correction applied to the sides according to the distances to the adjacent shots from the table.

9. A charged-particle beam lithographic apparatus as set forth in claim 7, wherein said beam shooting means includes blanking means for controlling shot times for which the charged-particle beam is shot based on the calculated proximity effect corrective values, shaped deflection means for determining the size of the shaped charged-particle beam based on the corrective shot data, and position deflection means for determining positions of the shaped charged-particle beam on the material surface based on the corrective shot data.
